(19) United States
(12) Patent Application Publication
(10) Pub. No.: US 2026/0167109 A1
(43) Pub. Date: Jun. 18, 2026

(54) DRIVING ASSISTANCE DEVICE, DRIVING ASSISTANCE METHOD, AND PROGRAM

(71) Applicant: TOYOTA JIDOSHA KABUSHIKI KAISHA, Aichi (JP)

(72) Inventor: Kazuki FUKAZAWA, Toyota-shi (JP)

(21) Appl. No.: 19/393,573

(22) Filed: Nov. 19, 2025

(30) Foreign Application Priority Data
Dec. 16, 2024 (JP) 2024-220240

(51) Int. Cl. B60R 1/27; B60Q 9/00; G06T 3/40; G06V 20/58

(52) U.S. Cl. CPC B60R 1/27; B60Q 9/008; G06T 3/40; G06V 20/58; B60R 2300/308; B60R 2300/8093

(57) ABSTRACT

The present invention enables appropriate notification to a user, through display, of the presence of an approaching object. A device includes an image display control unit configured to display, on a display device, a surrounding image captured by a camera that photographs an area around a vehicle, and to superimpose, on the surrounding image, detection information of an object detected by an object detection sensor. The device further includes an alert control unit configured to issue an alarm sound when a relative relationship between the detected object and the vehicle reaches a predetermined risk level. In addition, the device includes an enlarged control unit configured to display, on the display device, an enlarged image when an enlarged display request is received from a user, and an enlarged cancellation control unit configured to prohibit or cancel display of the enlarged image when a predetermined enlarged display cancellation condition is satisfied.

### CROSS-REFERENCE TO RELATED APPLICATION

This application claims priority to Japanese Patent Application No. JP2024-220240 filed on Dec. 16, 2024, the content of which is hereby incorporated by reference in its entirety into this application.

### BACKGROUND OF THE INVENTION

### 1. Field of the Invention

The present disclosure relates to a driving assistance device, a driving assistance method, and a program.

### 2. Description of the Related Art

For example, Japanese Patent Application Laid-Open (kokai) No. 2008-186132 discloses a driving assistance device that superimposes, on an image captured by an onboard camera, a display indicating a detection range of an onboard object detection sensor. When the object detection sensor detects an obstacle, the device stops the display of the detection range and instead displays an obstacle detection indication, thereby making it easier for occupants to recognize that an obstacle exists within the detection range.

In a system such as that disclosed in above Patent Literature, in which an obstacle detection indication is superimposed on a captured image, there exists a system equipped with a function that enlarges and displays a portion of the captured image in response to a request from a user (mainly a driver). In such a system, however, when a nearby object is detected in a direction that is no longer displayed due to the enlargement, there arises a problem in that the existence of the nearby object cannot be appropriately notified to the user through the display.

### SUMMARY OF THE INVENTION

The present disclosure has been made in view of the above problem, and aims to appropriately notify the user, through display, of the presence of an approaching object.

A device according to at least one embodiment of the present disclosure is a driving assistance device comprising: an image display control unit configured to display, on a display device provided inside a cabin of a vehicle, a surrounding image captured by a camera mounted on the vehicle and to superimpose, on the surrounding image, detection information of an object detected by an object detection sensor mounted on the vehicle, the detection information being displayed at a position corresponding to the detected object on the surrounding image; and
an alert control unit configured to perform an alert by an alarm sound when a relative relationship between the object detected by the object detection sensor and the vehicle reaches a predetermined risk level;
wherein the driving assistance device further comprises: an enlarged display control unit configured to display, on the display device, an enlarged image obtained by enlarging the surrounding image when an enlarged display request is received from a user; and
an enlarged display cancellation control unit configured to prohibit display of the enlarged image on the display device or to cancel display of the enlarged image that is being displayed on the display device when a predetermined enlarged display cancellation condition is satisfied, even if the enlarged display control unit has received the enlarged display request;
and wherein the enlarged display cancellation condition includes a case where the alert control unit is executing the alert.

### BRIEF DESCRIPTION OF THE DRAWINGS

FIG. 1 is a schematic diagram illustrating a hardware configuration of a vehicle according to the present embodiment.

FIG. 2 is a schematic diagram illustrating a software configuration of a control device according to the present embodiment.

FIG. 3A is a schematic diagram illustrating an example of a surrounding image according to the present embodiment.

FIG. 3B is a schematic diagram illustrating an example of an enlarged image according to the present embodiment.

FIG. 4 is a flowchart for explaining a routine of a cancellation process for enlargement display control according to the present embodiment.

### DESCRIPTION OF THE EMBODIMENTS

Hereinafter, a driving assistance device, a driving assistance method, and a program according to the present embodiment will be described with reference to the drawings.

### Hardware Configuration

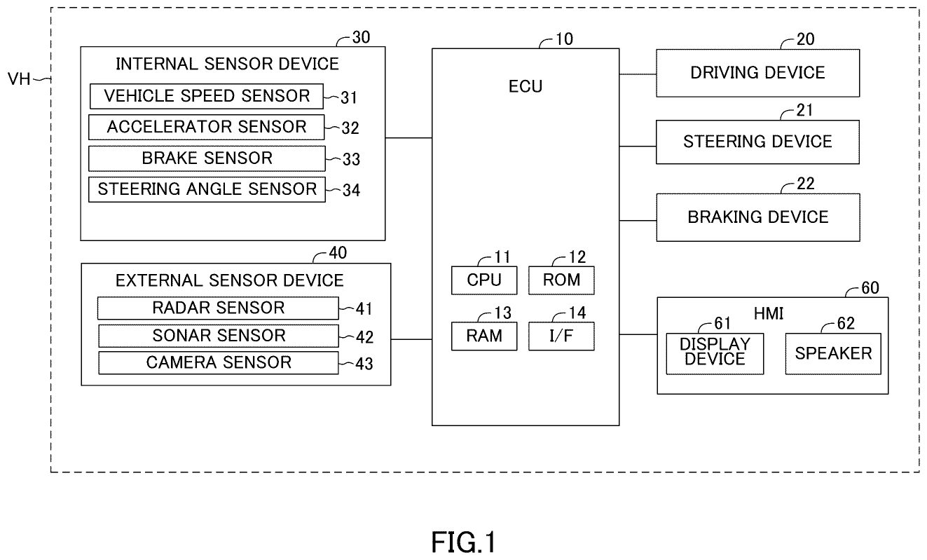

FIG. 1 is a schematic diagram illustrating a hardware configuration of a vehicle VH according to the present embodiment. In the following description, when it is necessary to distinguish the vehicle VH from other vehicles, it may be referred to as the host vehicle.

The vehicle VH includes an ECU (Electronic Control Unit) 10. The ECU 10 comprises a CPU (Central Processing Unit) 11, a ROM (Read Only Memory) 12, a RAM (Random Access Memory) 13, and an interface device 14, among others. The CPU 11 is a processor that executes various programs stored in the ROM 12. The ROM 12 is a nonvolatile memory that stores data and other information required for the CPU 11 to execute the various programs. The RAM 13 is a volatile memory that provides a work area for expanding and executing the various programs by the CPU 11. The interface device 14 is a communication device for communicating with external devices.

The ECU 10 serves as a central control unit that performs various types of driving assistance, including autonomous driving. The ECU 10 is communicably connected to a driving device 20, a steering device 21, a braking device 22, an internal sensor device 30, an external sensor device 40, and an HMI (Human Machine Interface) 60, among others.

The driving device 20 generates a driving force to be transmitted to the drive wheels of the vehicle VH. Examples of the driving device 20 include an electric motor and an engine. The steering device 21 applies a steering force to the wheels of the vehicle VH, while the braking device 22 applies a braking force to the wheels of the vehicle VH.

The internal sensor device 30 comprises sensors that detect the state of the vehicle VH. Specifically, the internal sensor device 30 includes a vehicle speed sensor 31, an accelerator sensor 32, a brake sensor 33, and a steering angle sensor 34. The vehicle speed sensor 31 detects the traveling speed of the vehicle VH, i.e., the vehicle speed. The accelerator sensor 32 detects the amount of operation of an accelerator pedal (not shown) by the driver. The brake sensor 33 detects the amount of operation of a brake pedal (not shown) by the driver. The steering angle sensor 34 detects the rotation angle of a steering wheel or steering shaft (not shown), i.e., the steering angle. The internal sensor device 30 transmits the detected state of the vehicle VH, obtained by each of the sensors 31 to 34, to the ECU 10 at predetermined intervals.

The external sensor device 40 comprises sensors that recognize target information relating to objects around the vehicle VH. Specifically, the external sensor device 40 includes a radar sensor 41, a sonar sensor 42, and a camera sensor 43, among others.

The radar sensor 41 includes a front radar sensor that recognizes the front of the vehicle VH, a rear radar sensor that recognizes the rear of the vehicle VH, a left-side radar sensor that recognizes the left side of the vehicle VH, and a right-side radar sensor that recognizes the right side of the vehicle VH. The radar sensor 41 includes a millimeter-wave radar and/or a LiDAR. The millimeter-wave radar emits radio waves in the millimeter-wave band and receives reflected waves reflected by an object within the emission range, thereby acquiring information such as the relative distance and relative speed between the vehicle VH and the object. The LiDAR sequentially scans pulsed laser beams, which have a wavelength shorter than that of millimeter waves, in multiple directions and receives reflected light reflected by the object, thereby acquiring information such as the shape of the object, the relative distance, and the relative speed between the vehicle VH and the object.

The sonar sensor 42 includes a front sonar sensor that recognizes the front of the vehicle VH, a rear sonar sensor that recognizes the rear of the vehicle VH, a left-side sonar sensor that recognizes the left side of the vehicle VH, and a right-side sonar sensor that recognizes the right side of the vehicle VH. The sonar sensor 42 emits ultrasonic waves and receives reflected waves reflected by an object within the emission range, thereby acquiring information such as the relative distance and relative speed between the vehicle VH and the object.

The camera sensor 43 includes a front camera sensor that captures the front of the vehicle VH, a rear camera sensor that captures the rear of the vehicle VH, a left-side camera sensor that captures the left side of the vehicle VH, and a right-side camera sensor that captures the right side of the vehicle VH. The camera sensor 43 may be, for example, a stereo camera or a monocular camera, and may employ a digital camera having an imaging element such as a CMOS or CCD. By processing the captured image data, the camera sensor 43 acquires information such as the shape of the object, the relative distance, and the relative speed between the vehicle VH and the object.

The external sensor device 40 transmits the acquired target information to the ECU 10 at predetermined intervals. Note that the external sensor device 40 does not necessarily have to include all of the radar sensor 41, the sonar sensor 42, and the camera sensor 43, and may include at least the sonar sensor 42 and the camera sensor 43.

The HMI (Human Machine Interface) 60 is an interface for inputting and outputting information between the ECU 10 and the driver, and includes an input device and an output device. Examples of the input device include a touch-panel-type liquid crystal display, switches, and a voice input microphone. Examples of the output device include a display device 61 and a speaker 62. The display device 61 may be, for example, a center display or a multi-information display. The speaker 62 may be, for example, a speaker of an audio system or a navigation system.

### Software Configuration

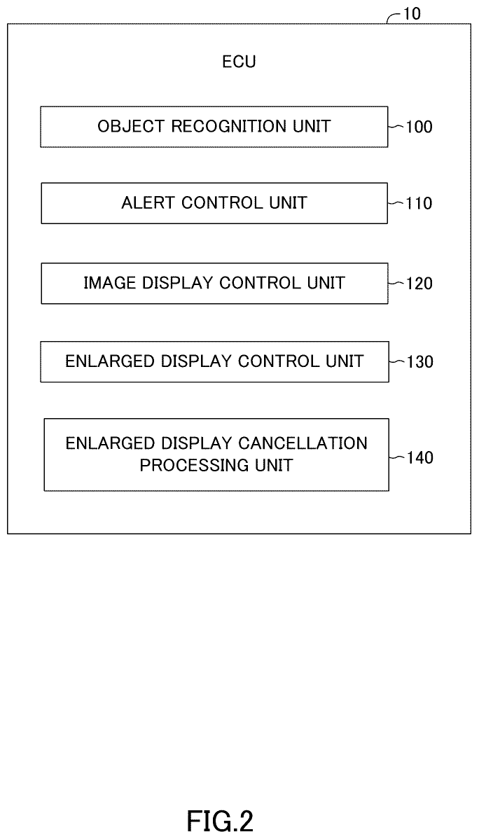

FIG. 2 is a schematic diagram illustrating a software configuration of the ECU 10 according to the present embodiment. As shown in FIG. 2, the ECU 10 includes, as functional components, an object recognition unit 100, an alert control unit 110, an image display control unit 120, an enlarged display control unit 130, and an enlarged display cancellation processing unit 140, among others. Each of these functional components 100 to 140 is implemented by the CPU 11 of the ECU 10 executing, on the RAM 13, programs stored in the ROM 12. It should be noted that all or some of the functional components 100 to 140 may alternatively be provided in another ECU separate from the ECU 10, or in an information processing apparatus of a facility (such as a management center) that is capable of communicating with the vehicle VH.

The object recognition unit 100 recognizes surrounding objects, such as stationary objects and moving objects that exist around the host vehicle VH based on detection results from the external sensor device 40. Specifically, the object recognition unit 100 recognizes the distance and direction between the host vehicle VH and surrounding objects existing around it, based on detection results from the external sensor device 40 (for example, the sonar sensor 42). The object recognition unit 100 transmits the recognition results of the surrounding objects (such as distance and direction) to the alert control unit 110 at predetermined intervals.

The alert control unit 110 executes alert control to warn the user when a nearby object approaching the host vehicle VH exists around the vehicle. Here, the term nearby object refers to an object that may constitute an obstacle when the host vehicle VH is traveling, or an object that approaches the host vehicle VH when it is stopped. When the distance between the host vehicle VH and a surrounding object recognized by the object recognition unit 100 becomes equal to or less than a predetermined threshold distance Dv, the alert control unit 110 determines that the collision risk between the host vehicle VH and the surrounding object has reached a predetermined risk level. When such a determination is made, the alert control unit 110 executes alert control to warn the user by sounding an alarm through the speaker 62 or a buzzer 63. Furthermore, when a cancellation request (for example, a mute operation) is received from the user, the alert control unit 110 deactivates the alert control—that is, even if the collision risk between the host vehicle VH and the surrounding object reaches the predetermined risk level, no alert control is executed. The user's cancellation request may be received, for example, through a touch operation on the screen of the display device 61, an on/off operation of a physical switch, or a voice recognition input via a microphone.

The image display control unit 120 generates, based on image data of the surroundings of the host vehicle VH captured by the camera sensor 43, a bird's-eye view image as seen from a virtual viewpoint, and executes image display control to display the generated bird's-eye view image as a surrounding image on the display device 61. Specifically, the image display control unit 120 projects the image data onto a predetermined projection surface (for example, a hemispherical surface), and generates a bird's-eye view image corresponding to a region within a predetermined viewing angle as seen from an arbitrary virtual viewpoint (for example, directly above the host vehicle VH). In addition, the image display control unit 120 superimposes the host vehicle VH at approximately the center position of the bird's-eye view image and superimposes surrounding objects detected by the external sensor device 40 at corresponding positions in the bird's-eye view image, thereby generating the surrounding image.

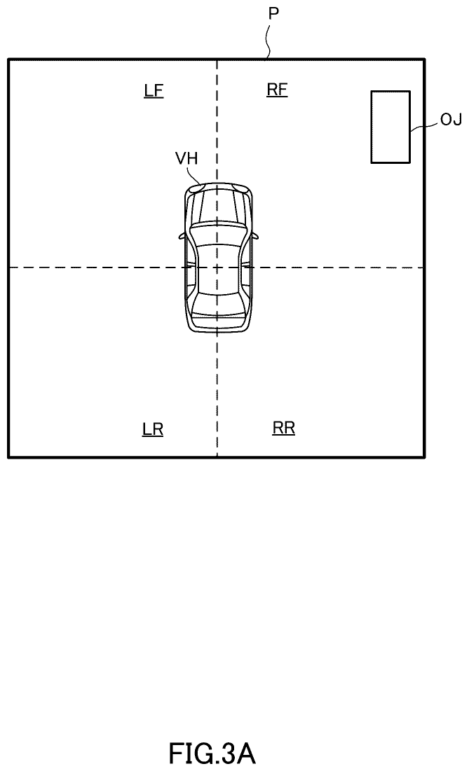

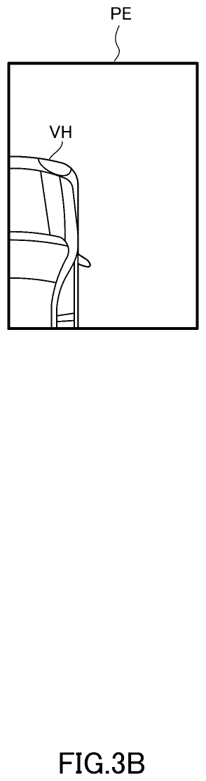

FIG. 3A is a schematic diagram illustrating an example of a surrounding image P displayed on the display device 61 by the image display control unit 120. In FIG. 3A, reference symbol VH denotes the host vehicle VH superimposed on the bird's-eye view image (for example, a polygon schematically indicating the shape of the host vehicle), and reference symbol OJ denotes a surrounding object superimposed on the bird's-eye view image. It should be noted that the surrounding image P is not limited to a bird's-eye view image as seen from directly above the host vehicle VH; it may also be, for example, a front-view image displaying the front side of the host vehicle VH.

The enlarged display control unit 130 executes enlarged display control in which, when an enlarged display request is received from the user, a portion of the surrounding image P corresponding to a position selected by the user is enlarged and displayed on the display device 61. The enlarged display request may be received, for example, when the user performs a tap operation on an arbitrary position of the surrounding image P displayed on the display device 61. As an example, in the surrounding image P shown in FIG. 3A, four regions—right-front (RF), left-front (LF), right-rear (RR), and left-rear (LR)—are defined by broken lines. When the user, for example, taps the right-front region RF, the enlarged display control unit 130 causes the display device 61 to display an enlarged image PE showing the right-front area of the host vehicle VH in an enlarged manner, as illustrated in FIG. 3B.

When the enlarged image PE is displayed on the display device 61 in response to a user's request for enlarged display during the execution of the alert control, there arises a problem in that it becomes difficult for the user to recognize the presence of a nearby object. Moreover, in a situation where the alert control is newly executed for another nearby object while the enlarged image PE is being displayed on the display device 61 in response to a user's request, if the enlarged display continues, the user may not be appropriately notified of the presence of the nearby object. Furthermore, consider a case where the user has recognized the nearby object due to execution of the alert control, performs a cancellation request (mute operation) of the alarm sound, and then additionally performs an enlarged display request. In such a situation, for example, when a new nearby object is detected in a direction outside the field of view of the enlarged image PE, or when the re-approach of a previously detected nearby object outside the field of view of the enlarged image PE is detected, there arises a problem in that the user cannot be appropriately notified of the presence of the nearby object. The enlarged display cancellation processing unit 140 executes a cancellation process that appropriately notifies the user, through display, of the presence of an approaching object by prohibiting or canceling execution of the enlarged display control depending on the situation. The details of the cancellation process will be described below.

### Scene 1

When the enlarged display control unit 130 receives a user's enlarged display request while the alert control unit 110 is executing the alert control, displaying the enlarged image PE on the display device 61 may result in a situation in which the nearby object is not included within the field of view of the enlarged image PE, making it difficult for the user to recognize its presence. In such a case, the enlarged display cancellation processing unit 140 prohibits the enlarged display control unit 130 from executing the enlarged display control. That is, the display device 61 continues to display the surrounding image P, which shows the entire surroundings of the host vehicle VH. This enables the user to be appropriately notified, through display, of the presence of the nearby object.

### Scene 2

When the enlarged display control unit 130 receives a user's enlarged display request and displays the enlarged image PE on the display device 61, and thereafter, the alert control unit 110 executes alert control due to detection of a new nearby object, continuing to display the enlarged image PE may result in a situation where the nearby object is not included within the field of view of the enlarged image PE, making it difficult for the user to recognize its presence. In such a case, the enlarged display cancellation processing unit 140 cancels the execution of the enlarged display control by the enlarged display control unit 130. That is, the display on the display device 61 is switched from the enlarged image PE to the surrounding image P, which displays the entire surroundings of the host vehicle VH. This enables the user to be appropriately notified, through display, of the presence of the newly detected nearby object.

### Scene 3

When the user recognizes the nearby object through execution of the alert control by the alert control unit 110, performs a cancellation request (mute operation) of the alarm sound, and then makes an enlarged display request, the user is already aware of the surrounding nearby objects. In such a situation, prohibiting the enlarged display would reduce the user's operability and convenience. Therefore, the enlarged display cancellation processing unit 140 does not prohibit execution of the enlarged display control by the enlarged display control unit 130. That is, execution of the enlarged display control is permitted.

### Scene 4

When the user recognizes the nearby object through execution of the alert control by the alert control unit 110, performs a cancellation request (mute operation) of the alarm sound, and then makes an enlarged display request so that the enlarged image PE is displayed on the display device 61, if, for example, the object recognition unit 100 detects a new nearby object from a new direction that is not included in the field of view of the enlarged image PE, continuing to display the enlarged image PE may make it difficult for the user to recognize the presence of the new nearby object. In such a case, the enlarged display cancellation processing unit 140 cancels the execution of the enlarged display control by the enlarged display control unit 130. That is, the display on the display device 61 is switched from the enlarged image PE to the surrounding image P, which displays the entire surroundings of the host vehicle VH. This enables the user to be appropriately notified, through display, of the presence of a new nearby object that has appeared from a new direction.

### Scene 5

When the user recognizes the nearby object through execution of the alert control by the alert control unit 110, performs a cancellation request (mute operation) of the alarm sound, and then makes an enlarged display request so that the enlarged image PE is displayed on the display device 61, if, for example, the object recognition unit 100 detects re-approach of a previously detected nearby object that is not displayed within the field of view of the enlarged image PE, continuing to display the enlarged image PE may make it difficult for the user to recognize the presence of the re-approaching nearby object. In such a case, the enlarged display cancellation processing unit 140 cancels the execution of the enlarged display control by the enlarged display control unit 130. That is, the display on the display device 61 is switched from the enlarged image PE to the surrounding image P, which displays the entire surroundings of the host vehicle VH. This enables the user to be appropriately notified, through display, of the presence of the re-approaching nearby object.

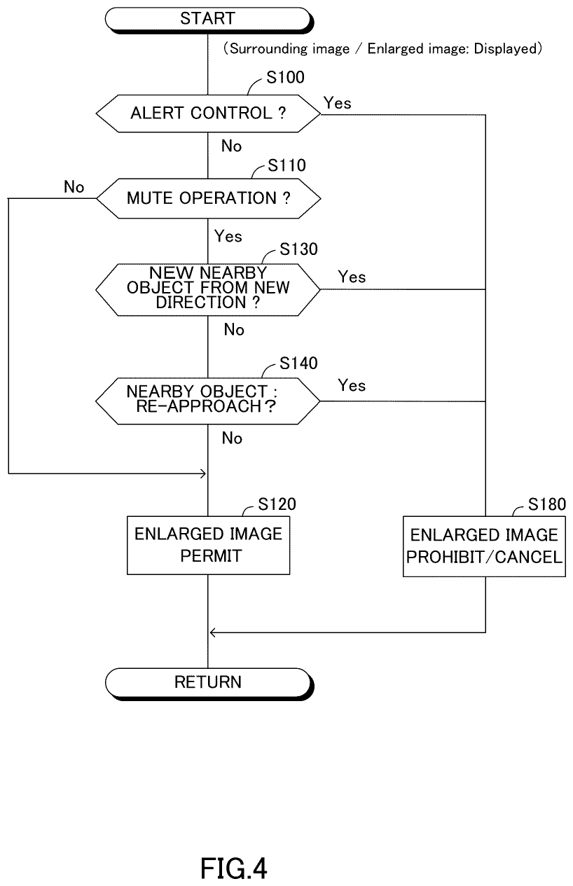

Next, with reference to the flowchart shown in FIG. 4, a routine of a cancellation process for the enlarged display control executed by the CPU 11 of the ECU 10 will be described. This routine is started, for example, when the surrounding image P or the enlarged image PE is displayed on the display device 61.

In Step S100, the ECU 10 determines whether alert control for sounding an alarm through the speaker 62 or buzzer 63 is being executed. If the alert control is being executed (Yes), the ECU 10 proceeds to the processing of Step S180. On the other hand, if the alert control is not being executed (No), the ECU 10 proceeds to the processing of Step S110.

In Step S180, the ECU 10 prohibits or cancels execution of the enlarged display control for displaying the enlarged image PE on the display device 61, and then returns this routine. Specifically, when the surrounding image P is being displayed on the display device 61, even if the user makes an enlarged display request, the ECU 10 prohibits display of the enlarged image PE. That is, the surrounding image P continues to be displayed on the display device 61. Further, when the enlarged image PE is being displayed on the display device 61, the ECU 10 cancels display of the enlarged image PE. That is, the display on the display device 61 is switched from the enlarged image PE to the surrounding image P.

In Step S110, the ECU 10 determines whether the user has made a cancellation request (mute operation) for the alarm sound. If the user has made the cancellation request (Yes), the ECU 10 proceeds to the processing of Step S130. On the other hand, if the user has not made the cancellation request (No), the ECU 10 proceeds to the processing of Step S120.

In Step S120, the ECU 10 permits execution of the enlarged display control for displaying the enlarged image PE on the display device 61, and then returns this routine. Specifically, when the surrounding image P is being displayed on the display device 61, if the user makes an enlarged display request, the ECU 10 causes the display device 61 to display the enlarged image PE. Also, when the enlarged image PE is already being displayed on the display device 61, the ECU 10 allows the enlarged image PE to continue being displayed.

In Step S130, the ECU 10 determines whether a new nearby object has been detected from a new direction that is not included in the field of view of the enlarged image PE. If a new nearby object has been detected from a new direction (Yes), the ECU 10 proceeds to the processing of Step S180, that is, prohibits or cancels execution of the enlarged display control, and then returns this routine. On the other hand, if no new nearby object is detected from a new direction (No), the ECU 10 proceeds to the processing of Step S140. It should be noted that the processes of Step S130 and Step S140 may be executed in any order.

In Step S140, the ECU 10 determines whether re-approach of a previously detected nearby object, which is not displayed within the field of view of the enlarged image PE, has been detected. If the re-approach of the nearby object has been detected (Yes), the ECU 10 proceeds to the processing of Step S180, that is, prohibits or cancels execution of the enlarged display control, and then returns this routine. On the other hand, if no re-approach of a nearby object is detected (No), the ECU 10 proceeds to the processing of Step S120, that is, permits execution of the enlarged display control, and then returns this routine.

It should be noted that the present disclosure is not limited to the above-described embodiment, and various modifications can be made without departing from the spirit and scope of the present invention.

For example, the technology of the present disclosure can also be applied to an autonomous driving vehicle that automatically performs part or all of the driving operations. In the case of an autonomous driving vehicle, the present disclosure may be applied when the driving operation is switched from fully automatic operation to manual operation.

What is claimed is:

1. A driving assistance device comprising:
an image display control unit configured to display, on a display device provided inside a cabin of a vehicle, a surrounding image captured by a camera mounted on the vehicle and to superimpose, on the surrounding image, detection information of an object detected by an object detection sensor mounted on the vehicle, the detection information being displayed at a position corresponding to the detected object on the surrounding image; and
an alert control unit configured to perform an alert by an alarm sound when a relative relationship between the object detected by the object detection sensor and the vehicle reaches a predetermined risk level;
wherein the driving assistance device further comprises:
an enlarged display control unit configured to display, on the display device, an enlarged image obtained by enlarging the surrounding image when an enlarged display request is received from a user; and
an enlarged display cancellation control unit configured to prohibit display of the enlarged image on the display device or to cancel display of the enlarged image that is being displayed on the display device when a predetermined enlarged display cancellation condition is satisfied, even if the enlarged display control unit has received the enlarged display request;
and wherein the enlarged display cancellation condition includes a case where the alert control unit is executing the alert.

2. The driving assistance device according to claim 1,
wherein the alert control unit is configured to cancel execution of the alert when a cancellation request is received from the user,
and wherein the enlarged display cancellation condition includes at least one of:
a first specific condition, in which the object detection sensor detects a new object different from the object that was a target of the canceled alert after the enlarged display control unit has received the enlarged display request while the alert has been canceled; and
a second specific condition, in which the object detection sensor detects that an object outside a field of view of the enlarged image is approaching the vehicle after the enlarged display control unit has received the enlarged display request while the alert has been canceled.

3. A driving assistance method for displaying, on a display device provided inside a cabin of a vehicle, a surrounding image captured by a camera mounted on the vehicle, and for superimposing, on the surrounding image, detection information of an object detected by an object detection sensor mounted on the vehicle at a position corresponding to the detected object,
the method comprising:
performing an alert by an alarm sound when a relative relationship between the object detected by the object detection sensor and the vehicle reaches a predetermined risk level;
displaying, on the display device, an enlarged image obtained by enlarging the surrounding image when an enlarged display request is received from a user; and
prohibiting display of the enlarged image on the display device or canceling display of the enlarged image being displayed on the display device when a predetermined enlarged display cancellation condition is satisfied even if the enlarged display request is received;
wherein the enlarged display cancellation condition includes a case where the alert is being executed.

4. A program for causing a computer of a driving assistance device to execute:
a process of displaying, on a display device provided inside a cabin of a vehicle, a surrounding image captured by a camera mounted on the vehicle and superimposing, on the surrounding image, detection information of an object detected by an object detection sensor mounted on the vehicle at a position corresponding to the detected object;
a process of performing an alert by an alarm sound when a relative relationship between the object detected by the object detection sensor and the vehicle reaches a predetermined risk level;
a process of displaying, on the display device, an enlarged image obtained by enlarging the surrounding image when an enlarged display request is received from a user; and
a process of prohibiting display of the enlarged image on the display device or canceling display of the enlarged image being displayed on the display device when a predetermined enlarged display cancellation condition is satisfied even if the enlarged display request is received;
wherein the enlarged display cancellation condition includes a case where the alert is being executed
